(19) United States
(12) Patent Application Publication
(10) Pub. No.: US 2023/0351729 A1
(43) Pub. Date: Nov. 2, 2023

(54) LEARNING SYSTEM, AUTHENTICATION SYSTEM, LEARNING METHOD, COMPUTER PROGRAM, LEARNING MODEL GENERATION APPARATUS, AND ESTIMATION APPARATUS

(71) Applicant: NEC Corporation, Minato-ku, Tokyo (JP)

(72) Inventors: Masato TSUKADA, Tokyo (JP); Takahiro TOIZUMI, Tokyo (JP); Ryuichi AKASHI, Tokyo (JP)

(73) Assignee: NEC Corporation, Minato-ku, Tokyo (JP)

(21) Appl. No.: 17/638,900

(22) PCT Filed: Mar. 29, 2021
(86) PCT No.: PCT/JP2021/013275

§ 371 Date: Feb. 28, 2022

(51) Int. Cl. G06V 10/774; G06F 21/32; G06V 40/18; G06V 10/776

(52) U.S. Cl. CPC G06V 10/774; G06F 21/32; G06V 40/193; G06V 40/197; G06V 10/776

(57) ABSTRACT

A learning system (10) comprises: a selection unit (110) that selects from images corresponding to a plurality of frames shot at a first frame rate, part of the images, the part including an image taken outside a focus range; an extraction unit (120) that extracts a feature amount from the part of the images; and a learning unit (130) that performs learning for the extraction unit based on the feature amount extracted and correct answer information indicating a correct answer with respect to the feature amount. According to such a learning system, it is possible to execute machine learning assumed that moving images are shot at a low frame rate.

### TECHNICAL FIELD

This disclosure relates to the technical fields of learning systems, authentication systems, learning methods, computer programs, learning model generation apparatus, and estimation apparatus that each perform machine learning.

### BACKGROUND ART

As a system of this kind, there is known a system which perform machine learning using image data as training data. For example, Patent Document 1 discloses a technique using an image of a living body, in which parameters are optimized at the time of extracting the feature amount from the image. Patent Document 2 discloses a technique for learning from a moving image frame outputted from a vehicle-mounted camera, the co-occurrence feature amount of an image where a pedestrian is captured. Patent Document 3 discloses a technique for learning the neural network by calculating the gradient from the loss function.

As other related art, for example, Patent Document 4 discloses an apparatus which identifies from image data of a moving image frame, whether a predetermined identification target is present in an image. Patent Document 5 discloses a technique for detecting the image feature amount of a vehicle from a low resolution image in order to estimate a position of a predetermined area in a moving image.

### CITATION LIST

### Patent Document

Patent Document 1: WO No. 2019/073745
Patent Document 2: WO No. 2018/143277
Patent Document 3: JP-A-2019-185207
Patent Document 4: JP-A-2019-061495
Patent Document 5: JP-A-2017-211760

### SUMMARY

### Technical Problem

This disclosure has been made, for example, in view of the above-mentioned respective cited documents. It is an object of the present disclosure to provide a learning system, an authentication system, a learning method, a computer program, a learning model generation apparatus, and an estimation apparatus, each being capable of appropriately performing machine learning.

### Solution to Problem

One aspect of a learning system of the disclosure comprises: a selection unit that selects from images corresponding to a plurality of frames shot at a first frame rate, part of the images, the part including an image taken outside a focus range; an extraction unit that extracts a feature amount from the part of the images; and a learning unit that performs learning for the extraction unit based on the feature amount extracted and correct answer information indicating a correct answer with respect to the feature amount.

One aspect of an authentication system of this disclosure comprises an extraction unit and an authentication unit, wherein the extraction unit selects from images corresponding to a plurality of frames shot at a first frame rate, part of the images, the part including an image taken outside a focus range, and extracts a feature amount from the part of the images, the extract unit being learned based on the feature amount extracted and correct answer information indicating a correct answer with respect to the feature amount; and the authentication unit executes an authentication process using the feature amount extracted.

One aspect of a learning method of the disclosure comprises: selecting from images corresponding to a plurality of frames shot at a first frame rate, part of the images, the part including an image taken outside a focus range; extracting a feature amount from the part of the images; and performing for the extraction based on the feature amount extracted and correct answer information indicating a correct answer with respect to the feature amount.

One aspect of a computer program of this disclosure allows a computer to: select from images corresponding to a plurality of frames shot at a first frame rate, part of the images, the part including an image taken outside a focus range; extract a feature amount from the part of the images; and perform learning for the extraction based on the feature amount extracted and correct answer information indicating a correct answer with respect to the feature amount.

One aspect of a learning model generation apparatus of the present disclosure, generates performing machine learning where a pair of an image taken outside a focus range and information indicating a feature amount of the image is used as teacher data, a learning model that uses an image taken outside the focus range as input image and outputs information about a feature amount of the input image.

One aspect of an estimation apparatus of this is disclosure uses with a learning model generated by performing machine learning where a pair of an image taken outside a focus range and information indicating a feature amount of the image is used as teacher data, an image taken outside the focus range as an input image to estimate a feature amount of the input image.

### BRIEF DESCRIPTION OF DRAWINGS

FIG. 1 is a block diagram showing a hardware configuration of a learning system according to the first example embodiment.

FIG. 2 is a block diagram showing a functional configuration of a learning system according to the first example embodiment.

FIG. 3 is a conceptual diagram showing an example of a method of selecting an image used for learning.

FIG. 4 is a flowchart showing a flow of operations of a learning system according to the first example embodiment.

FIG. 5 is a block diagram showing a functional configuration of a learning system according to a variation of the first example embodiment.

FIG. 6 is a flowchart showing a flow of operations of the learning system according to a variation of the first embodiment.

FIG. 7 is a conceptual diagram showing an operation example of a learning system according to the second example embodiment.

FIG. 8 is a conceptual diagram showing an operation example of a learning system according to the third example embodiment.

FIG. 9 is a conceptual diagram showing an operation example of a learning system according to the fourth example embodiment.

FIG. 10 is a table showing an operation example of a learning system according to the fifth example embodiment.

FIG. 11 is a conceptual diagram showing an operation example of a learning system according to the sixth example embodiment.

FIG. 12 is a conceptual diagram showing an operation example of a learning system according to the seventh example embodiment.

FIG. 13 is a block diagram showing a functional configuration of an authentication system according to the eighth example embodiment.

FIG. 14 is a flowchart showing a flow of operations of an authentication system according to the eighth example embodiment.

FIG. 15 is a block diagram showing a functional configuration of a learning model generation apparatus according to the ninth example embodiment.

FIG. 16 is a block diagram showing a functional configuration of an estimation apparatus according to the tenth example embodiment.

### DESCRIPTION OF EXAMPLE EMBODIMENTS

Referring to the drawings, example embodiments of the learning system, the authentication system, the learning method, the computer program, the learning model generation apparatus, and the estimation apparatus will be described below.

### First Example Embodiment

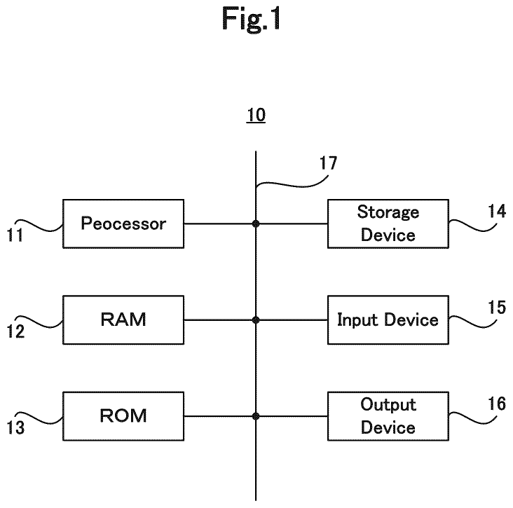

The learning system according to a first example embodiment will be described with reference to FIGS. 1 through 4.

### (Hardware Configuration)

First, referring to FIG. 1, the hardware configuration of the learning system 10 according to the first example embodiment will be described. FIG. 1 is a block diagram of the hardware configuration of the learning system according to the first example embodiment.

As shown in FIG. 1, the learning system 10 according to the first example embodiment comprises a processor 11, a RAM (Random Access Memory) 12, a ROM (Read Only Memory) 13, and a storage device 14. The learning system 10 may further comprises an input device 15 and an output device 16. The processor 11, the RAM 12, the ROM 13, the storage device 14, the input device 15, the output device 16, and a camera 20 are connected via a data bus 17.

The processor 11 reads a computer program. For example, the processor 11 is configured to read the computer program stored in at least one of the RAM 12, the ROM 13, and the storage device 14. Alternatively, the processor 11 may read the computer program stored in a computer-readable recording medium, using a recording medium reading device not illustrated. The processor 11 may acquire (i.e., read) the computer program from an unillustrated device located outside the learning system 10 via a network interface. The processor 11 executes the read computer program to control the RAM 12, the storage device 14, the input device 15, and the output device 16. In the present embodiment, in particular, when the processor 11 executes the read computer program, functional blocks for executing processing related to machine learning are realized in the processor 11. Further, one of a CPU (Central Processing Unit), a GPU (Graphics Processing Unit), an FPGA (field-programmable gate array), a DSP (Demand-Side Platform), and an ASIC (Application Specific Integrated Circuit) may be employed as the processor 11, or more than one of them may be employed in parallel.

The RAM 12 temporarily stores the computer program to be executed by the processor 11. The RAM 12 temporarily stores data which is temporarily used by the processor 11 when the processor 11 is executing the computer program. D-RAM (Dynamic RAM) may be employed as the RAM 12, for example.

The ROM 13 stores the computer program to be executed by the processor 11. The ROM 13 may also store other fixed data. P-ROM (Programmable ROM) may be employed as the ROM 13, for example.

The storage device 14 stores data that the learning system 10 stores for a long term. The storage device 14 may act as a temporary storage device for the processor 11. The storage device 14 may include, for example, at least one of a hard disk drive, an optical magnetic disk drive, an SSD (Solid State Drive), and a disk array device.

The input device 15 is a device that receives input instructions from users of the learning system 10. The input device 15 may include, for example, at least one of a keyboard, a mouse, and a touch panel.

The output device 16 is a device that outputs information on the learning system 10 to the outside. For example, the output device 16 may be a display device (e.g., a display) that can show the information on the learning system 10.

### (Functional Configuration)

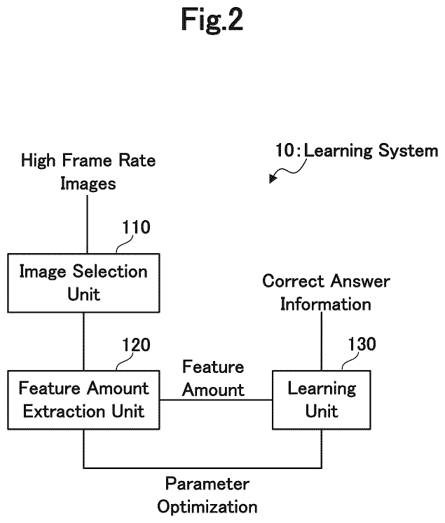

Next, with reference to FIG. 2, a functional configuration of the learning system 10 according to the first example embodiment will be described. FIG. 2 is a block diagram showing the functional configuration of the learning system according to the first example embodiment.

As shown in FIG. 2, the learning system 10 according to the first example embodiment comprises an image selection unit 110, a feature amount extraction unit 120, and a learning unit 130 as processing blocks for realizing functions of the learning system 10. The image selection unit 110, the feature amount extraction unit 120, and the learning unit 130 may be each realized in the processor 11 (see FIG. 1) described above, for example.

The image selection unit 110 is configured to be able to from images corresponding to a plurality of frames shot at the first frame rate, part of the images. Here, the “first frame rate” is a frame rate when the images are taken as a selection source for the image selection unit 110. The “first frame rate” is set as a relatively high rate. In the following, a plurality of frame rate images shot at the first frame rate are referred to as “high frame rate images” as appropriate. The image selection unit 110 selects from the high frame rate images, part of the images, the part including an image taken outside the focus range (in other words, an out-of-focus blurred image). The number of the part selected by the image selection unit 110 is not particularly limited. Only one image may be selected, or a plurality of images may be selected. The image selection unit 110 is configured to output the part selected by the image selection unit 110 to the feature amount extraction unit 120.

The feature amount extraction unit 120 is configured to be capable of extracting the feature amount from the image selected by the image selecting unit 110 (hereinafter, referred to as a “selected image” as appropriate). The “feature amount” here indicates characteristics of the image. The “feature amount” may be extracted, for example, as a value indicating characteristics of an object included in the image. The feature amount extraction unit 120 may extract a plurality of types of feature amount from a single image. In addition, when there are a plurality of selected images, the feature amount extraction unit 120 may extract the feature amount for each of the plurality of selected images. As for the specific technique for extracting the feature amount from an image, the existing technique can be adopted as appropriate. Therefore, for the specific method, a detailed description thereof will be omitted. The feature amount extraction unit 120 is configured to output the feature amount extracted by the feature amount extraction unit 120 to the learning unit 130.

The learning unit 130 performs learning for the feature amount extraction unit 120 on the basis of the feature amount extracted by the feature amount extraction unit 120 and correct answer information indicating a correct answer with respect to the feature amount. Specifically, the learning unit 130 performs optimization of parameters so that the feature amount extraction unit 120 can extract the feature amount with higher accuracy based on the feature amount extracted by the feature amount extraction unit 120 and the correct answer information. Here, the “correct answer information” is information indicating the feature amount (in other words, the feature amount actually included in the image), which the feature amount extraction unit 120 should extract from the image selected by the image selection unit 110. The correct answer information has been provided in advance as a correct label of each image. The correct answer information, for example, may be stored so as to be linked with the image, or may be inputted separately from the image. The correct answer information may be information estimated from the image, or may be created by human work. The learning unit 130 typically performs learning for the feature amount extraction unit 120 using the plurality of selected images. As for the specific method of learning by the learning unit 130, the existing technique can be adopted as appropriate. Therefore, a detailed description thereof will be omitted here.

### (Image Selection)

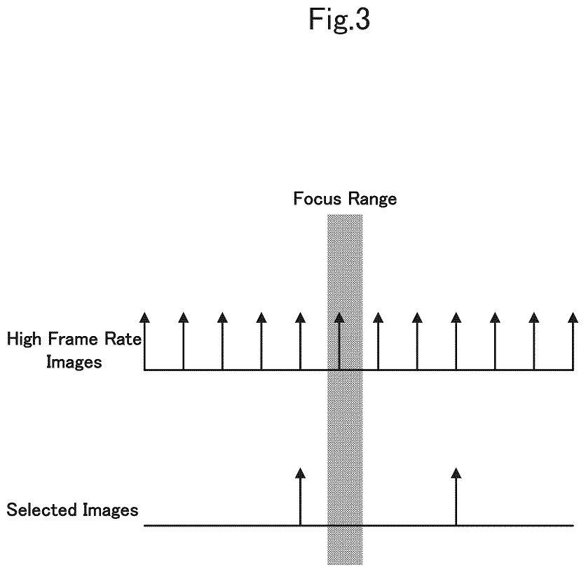

Next, with reference to FIG. 3, a method for selecting an image by the image selection unit 110 described above will be specifically described. FIG. 3 is a conceptual diagram illustrating an example of a method of selecting an image to be used for learning.

In FIG. 3, an upward arrow represents each one of the images that are continuously taken. The high frame rate images are obtained by shooting an object moving to pass through the focus range of the imaging unit at a first frame rate.

The image selection unit 110 selects from the high frame rate images, part of the images. Although two images are selected here, the image selection unit 110 may select two or more images, or may select only one image. The image selection unit 110 may randomly select the selected images. Alternatively, the image selection unit 110 may select an image based on a predetermined selection condition. More specific examples of image selection by the image selection unit 110 will be described in detail in later example embodiments.

The selected images include an image taken outside the focus range, as already described. The image taken outside the focus range is somewhat blurred. Therefore, it is difficult to extract an accurate feature amount by the feature amount extraction unit. In this way, in the learning system 10 according to the present example embodiment, an image taken outside the focus range is used daringly, and then, learning is performed so that the feature amount can be accurately extracted even from a blurred image.

Depending on the size of or the frame rate of the focus range, even in the high frame rate images, images taken in the focus range corresponds to a small part (in the example shown in FIG. 3, only one image taken in the focus range). Therefore, when trying to acquire an image taken reliably in the focus range, it would be required to take images at a high frame rate. Alternatively, it would be required to adjust the focus range using a device such as a liquid-lens.

In order to satisfy the above requirements, it is difficult to avoid an increase in cost. However, if learning is performed so that the feature amount is accurately extracted even from blurred images, it is not required to take images within the focus range. As a result, it becomes possible to extract the feature amount with high accuracy while suppressing an increase in cost.

### (Operation Flow)

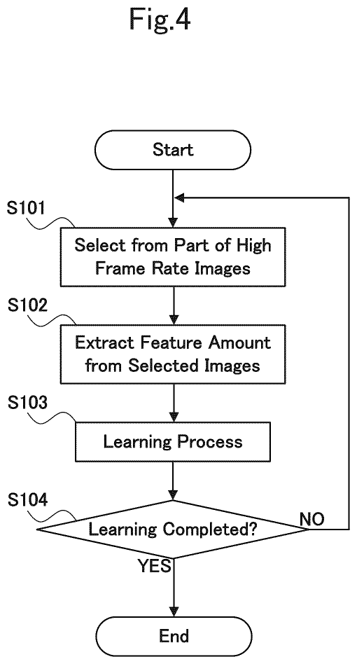

Next, a flow of operations of the learning system 10 according to the first example embodiment will be described with reference to FIG. 4. FIG. 4 is a flowchart illustrating the flow of the operations of the learning system according to the first example embodiment.

As shown in FIG. 4, when the learning system 10 according to the first example embodiment operates, first, the image selection unit 110 selects from the high frame rate images, part of the images (Step S101). The image selection unit 110 outputs the selected images to the feature amount extraction unit 120.

Subsequently, the feature amount extraction unit 120 extracts the feature amount from the selected images (Step S102). The feature amount extraction unit 120 outputs the extracted feature amount to the learning unit 130.

Subsequently, the learning unit 130 performs a learning process for the feature amount extraction unit 120 on the basis of the feature amount extracted by the feature amount extraction unit 120 and the correct answer information of the feature amount (Step S103).

Subsequently, the learning unit 130 determines whether or not all the learning has been completed (Step S104). The learning unit 130 may determine that the learning has been completed, for example, when the number of selected images used for the learning reaches a predetermined number. Or, the learning unit 130 may determine that the learning has been completed when a predetermined period has elapsed since the learning starts. The learning unit 130 may determine that the learning has been completed when a termination operation is performed by a system administrator.

If it is determined that the learning has been completed (Step S104: YES), the sequence of processes ends. On the other hand, when it is determined that the learning has not yet been completed (Step S104: NO), the processing may be started from Step S101 again.

### Technical Effects

Next, technical effects obtained by the learning system 10 according to the first example embodiment will be described.

As described in FIGS. 1 through 4, in the learning system 10 according to the first example embodiment, from the high frame rate images the part of the images are selected, and the learning for the feature amount extraction unit 120 is performed using the feature amount extracted from the selected images. If the feature amount extraction unit 120 is learned in this way, it is possible to accurately extract the feature amount even if an image is not taken in the focus range. Therefore, it is not required to take an image in the focus range, and it is possible to suppress a cost increase of the imaging unit and the like.

### Variation

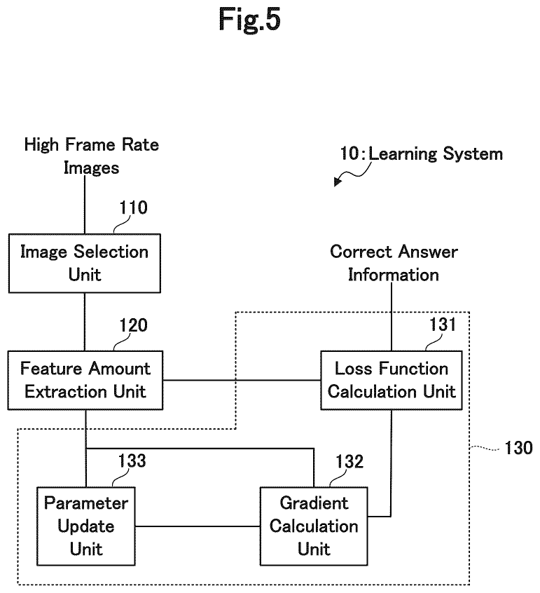

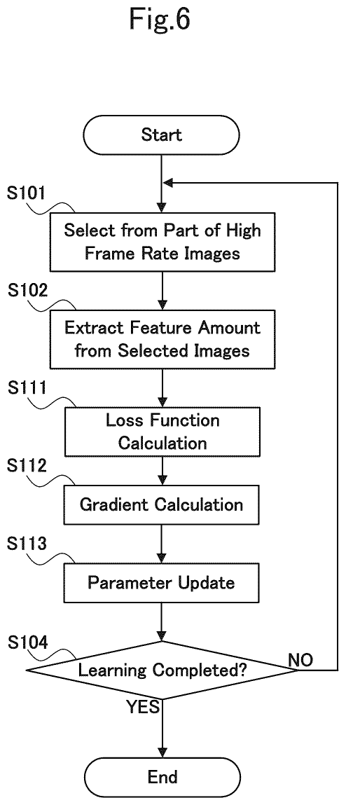

A variation of the first example embodiment will be described with reference to FIGS. 5 and 6. The variation described below are only different in some configurations and operations as compared with the first example embodiment. Other parts may be the same as in the first example embodiment (see FIGS. 1 through 4). For this reason, in the following, the parts that differ from the first example embodiment already described will be explained in detail, and descriptions of the other parts, overlapping descriptions, will be omitted as appropriate.

### Configuration of Variation

First, a functional configuration of the learning system 10 according to the variation of the first example embodiment will be described with reference to FIG. 5. FIG. 5 is a block diagram illustrating a functional configuration of the learning system according to the variation of the first example embodiment. In FIG. 5, the reference signs same as in FIG. 2 are assigned to the elements same as in FIG. 2 respectively.

As shown in FIG. 5, the learning system 10 according to the variation of the first example embodiment is configured to comprise the image selection unit 110, the feature amount extraction unit 120, and the learning unit 130 as processing blocks for realizing the functions of the learning system 10. In particular, in the learning system 10 according to the variation, the learning unit 130 comprises a loss function calculation unit 131, a gradient calculation unit 132, and a parameter update unit 133.

The loss function calculation unit 131 is configured to be capable of calculating a loss function based on an error between the feature amount extracted by the feature amount extraction unit 120 and the correct answer information of the feature amount. As for the calculation method of the loss function, existing techniques can be adopted as appropriate, and detailed explanations here are omitted.

The gradient calculation unit 132 is configured to be capable of calculating the gradient, using the loss function calculated by the loss function calculation unit 131. As for the specific calculation method of the gradient, existing techniques may be adopted as appropriate, and detailed explanations here are omitted.

The parameter update unit 133 is configured to be capable of updating parameters (that is, parameters for extracting the feature amount) in the feature amount extraction unit 120 on the basis of the gradient calculated by the gradient calculation unit 132. The parameter update unit 133 updates the parameters so that the loss calculated by the loss function is reduced. Thereby, the parameter update unit 133 optimizes the parameter so that the feature amount is estimated as information closer to the correct answer information.

### (Operations of Variation)

Next, a flow of operations of the learning system according to the variation of the first example embodiment will be described with reference to FIG. 6. FIG. 6 is a flowchart illustrating a flow of the operations of the learning system according to the variation of the first example embodiment. In FIG. 6, reference signs same as in FIG. 4 are assigned to the processes similar to in FIG. 4 respectively.

As shown in FIG. 6, when the learning system 10 according to the variation of the first example embodiment operates, first, the image selection unit 110 selects from the high frame rate images, part of the images (Step S101). The image selection unit 110 outputs the selected images to the feature amount extraction unit 120.

Subsequently, the feature amount extraction unit 120 extracts the feature amount from the selected images (Step S102). The feature amount extraction unit 120 outputs the extracted feature amount to the loss function calculation unit 131 in the learning unit 130.

Subsequently, the loss function calculating unit 131 calculates the loss function based on the feature amount inputted from the feature amount extraction unit 120 and the correct answer information inputted separately (Step S111). Then, the gradient calculation unit 132 calculates the gradient using the loss function (Step S112). Thereafter, the parameter update unit 133 updates the parameters of the feature amount extraction unit 120 based on the calculated gradient (Step S113).

Subsequently, the learning unit 130 determines whether or not all the learning has been completed (Step S104). If it is determined that the learning has been completed (Step S104: YES), the sequence of processes ends. On the other hand, when it is determined that the learning has not yet been completed (Step S104: NO), that processing may be started from Step S101 again.

### (Effects of Variation)

Next, technical effects obtained by the learning system 10 according to the variation of the first example embodiment will be described.

As described in FIG. 5 and FIG. 6, in the learning system 10 according to the variation of the first example embodiment, the parameters of the feature amount extraction unit 120 are updated based on the gradient calculated from the loss function. When the feature amount extraction unit 120 is learned in this way, similarly to the learning system 10 according to the first example embodiment described above, also the feature amount can be accurately extracted even if an image is not captured in the focus range. Therefore, it is not required to capture an image in the focus range, and It is possible to suppress a cost increase of the imaging unit and the like.

### Second Example Embodiment

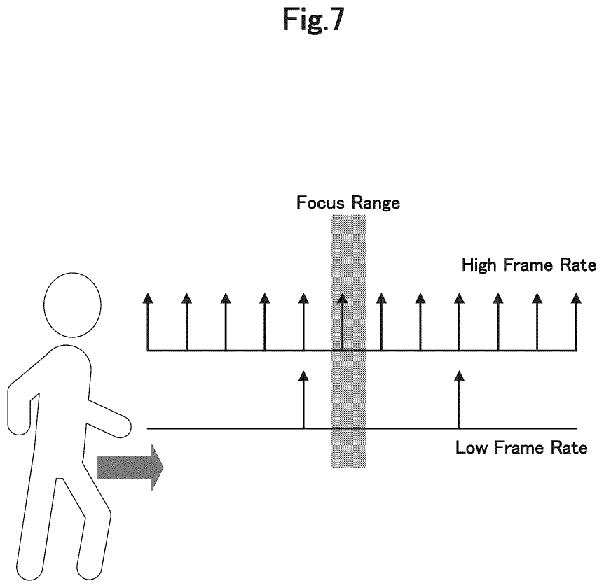

The learning system 10 according to a second example embodiment will be described with reference to FIG. 7. The second example embodiment differs only in some configurations and some operations as compared with the first example embodiment, and with respect to the others the second example embodiment may be the same as the first example embodiment (see FIGS. 1 through 6). Therefore, in the following, the descriptions overlapping with the first example embodiment already described are omitted as appropriate.

### (Operation Example)

First, an operation example of the learning system 10 according to the second example embodiment will be described with reference to FIG. 7. FIG. 7 is a conceptual diagram illustrating an operation example of the learning system according to the second example embodiment.

The learning system 10 according to the second example embodiment uses an image including an iris of a living body as the high frame rate image. Therefore, the selected images selected by the image selection unit 110 also each include the iris of the living body. Then, the feature amount extraction unit 120 according to the second example embodiment is configured to be capable of extracting the feature amount of the iris from the image including the iris of the living body (hereinafter, referred to as an “iris image” as appropriate). The feature amount extraction unit 120 extracts the feature amount t to be used for iris authentication after learning by the learning unit 130.

As shown in FIG. 7, in a system that performs the iris authentication, sometimes adopted is a mode (so-called walk-through authentication) in which the iris image is taken while a target person as the authentication target is moving. In such an authentication system, the iris of the target person is located within the focused range for a very short period of time. For example, in a case that the target person walks at 80 meters per minute (1.333 centimeters per second), which is the normal walking velocity of an adult, and the depth of field (the focus range) is 1 centimeter at the shooting position of optical lenses in the imaging system, even if the iris image is taken at 120 FPS (interval of 8.33 ms), one or two iris images can be taken within the focus range. Therefore, when the iris image is taken at a low frame rate, for example, 30 FPS, there is a possibility that it is impossible to take the iris image within the focus range. That is, there is a possibility that all iris images are taken outside the focus range.

The learning system 10 according to the second example embodiment performs learning for a situation that the iris image is taken at the above-described low frame rate. That is, from the iris images taken at a high frame rate, the part of the iris images are selected, and this makes it possible to perform learning using daringly the iris image taken outside the focus range.

### Technical Effects

Next, technical effects obtained by the learning system 10 according to the second example embodiment will be described.

As described in FIG. 7, in the learning system 10 according to the second example embodiment, the feature amount extraction unit 120 for extracting the feature amount of the iris is learned using the part of the iris images selected from the high frame rate images. Thereby, it is possible to learn for extracting the feature amount with high accuracy even from the iris image taken outside the focus range. Therefore, it is not required to take an image in the focus range, and it is possible to suppress the cost increase of the imaging unit and the like.

### Third Example Embodiment

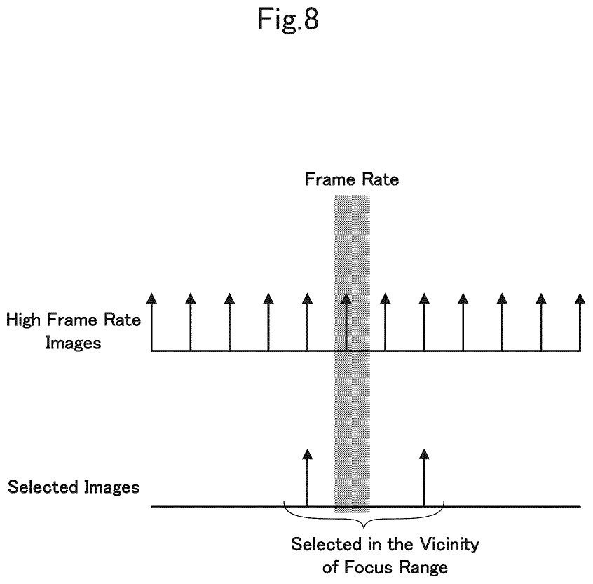

The learning system 10 according to a third example embodiment will be described with reference to FIG. 8. The third example embodiment differs only in some configurations and operations as compared with the first and second example embodiments described above, and with respect to the others the third example embodiment may be the same as the first and second example embodiments. Accordingly, in the following, the descriptions overlapping with the example embodiments already described will be omitted as appropriate.

### Operation Example

First, an operation example of the learning system 10 according to the third example embodiment will be described with reference to FIG. 8. FIG. 8 is a conceptual diagram illustrating an operation example of the learning system according to the third example embodiment.

As shown in FIG. 8, in the learning system 10 according to the third example embodiment, the image selection unit 110 selects images in the vicinity of the focus range within the high frame rate images. One of this selection method may include the steps of: obtaining the amount of high-frequency component with respect to the high frame rate images using a high-pass filter, Fourier transform or the like; and selecting an image whose high-frequency component exceeds a predetermined threshold. Alternatively, the selection method may include the steps of: measuring a distance to the iris of the pedestrian by a distance sensor: and calculating a difference from a distance to the focus position; and selecting an image, with respect to which the calculated difference is less than a predetermined distance difference. Here, “the vicinity of the focus range” means positions relatively close to the focus range. “The vicinity of the focus range” is set as, for example, a range that falls within a predetermined distance from the end of the focus range. Further, the vicinity of the focus range may include both the portion before the focus range and the portion after the focus range. When a plurality of images is included in the vicinity of the focus range, the image selection unit 110 may select one of the plurality of images, or may select two or more images of the plurality of images. At this time, the image selection unit 110 may randomly select images in the vicinity of the image range.

### Technical Effects

Next, technical effects obtained by the learning system 10 according to the third example embodiment will be described.

As described in FIG. 8, in the learning system 10 according to the third example embodiment, the images in the vicinity of the focus range are selected as the selected images. In this way, learning can be performed using images with a relatively low degree of blur though the images were taken outside the focus range. Therefore, it is possible to avoid that appropriate learning cannot be performed because of use of images taken too out of focus range (i.e., too blurry images). Further, since it is supposed that an image in the vicinity of the focus range can be obtained somewhat even when images are taken at a low frame rate. Therefore, the learning can be carried out under the condition suitable for the actual operation.

### Fourth Example Embodiment

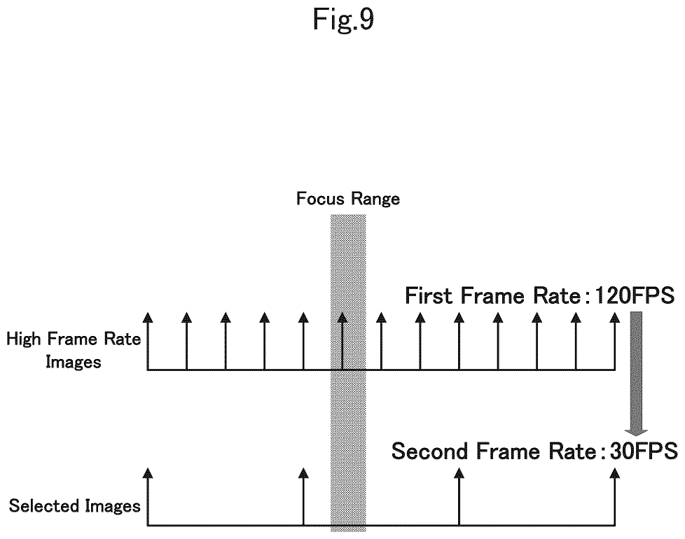

The learning system 10 according to a fourth example embodiment will be described with reference to FIG. 9. The fourth example embodiment only differs in some configurations and operations as compared with the first through third example embodiments described above, and with respect to the others the fourth example embodiment may be the same as the first through third example embodiments. Accordingly, in the following, the descriptions overlapping with the example embodiments already described will be omitted as appropriate.

### Operation Example

First, an operation example of the learning system 10 according to the fourth example embodiment will be described with reference to FIG. 9. FIG. 9 is a conceptual diagram illustrating an operation example of the learning system according to the fourth example embodiment.

As shown in FIG. 9, in the learning system 10 according to the fourth example embodiment, the image selection unit 110 selects images corresponding to a second frame rate lower than the first frame rate (that is, the frame rate at which the high frame rate image is taken). FIG. 9 shows an example where the first frame rate is 120 FPS, and the second frame rate is 30 FPS. Therefore, the high frame rate image is selected one by one every four sheets. The selected images are selected at equal intervals according to the second frame rate.

### Technical Effects

Next, technical effects obtained by the learning system 10 according to the fourth example embodiment will be described.

As described in FIG. 8, in the learning system 10 according to the fourth example embodiment, images corresponding to the second frame rate lower than the first frame rate are selected. Frame images for learning are selected from high frame rate data by the above-described selection method. By using the selected frame images for learning, it is possible to learn the optimal network for estimating the low frame rate.

### Fifth Example Embodiment

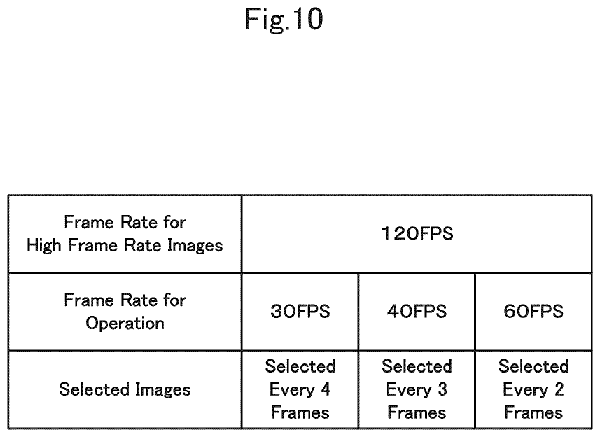

The learning system 10 according to a fifth example embodiment will be described with reference to FIG. 10. The fifth example embodiment only differs in some configurations and operations as compared with the fourth example embodiment described above, and with respect to the others the fifth example embodiment may be the same as the first through fourth example embodiments. Accordingly, in the following, the descriptions overlapping with the example embodiments already described will be omitted as appropriate.

### Operation Example

First, an operation example of the learning system 10 according to the fifth example embodiment will be described with reference to FIG. 10. FIG. 10 is a table showing an operation example of the learning system according to the fifth example embodiment.

In the learning system 10 according to the fifth example embodiment, a frame rate (that is, a second frame) at which the image selection unit 110 selects images is set as a frame rate for operation of the feature amount extraction unit 120 after learning. That is, under assumption of the frame rate of images which are inputted to the feature amount extraction unit 120 after learning, from the high frame rate images part of the images are selected.

As shown in FIG. 10, for example, a high frame rate images are images taken by 120 FPS. In this case, when the frame rate for operation of the feature amount extraction unit 120 is 30 FPS, the image selection unit 110 selects images corresponding to 30 FPS from the high frame rate images. Specifically, the image selection unit 110 selects the high frame rate images every four frames. Alternatively, when the frame rate for operation of the feature amount extraction unit 120 is 40 FPS, the image selection unit 110 selects images corresponding to 40 FPS from the high frame rate images. Specifically, the image selection unit 110 selects the high frame rate images every three frames. Alternatively, when the frame rate for operation of the feature amount extraction unit 120 is 60 FPS, the image selection unit 110 selects images corresponding to 60 FPS from the high frame rate images. Specifically, the image selection unit 110 selects the high frame rate images every two frames.

### Technical Effects

Next, technical effects obtained by the learning system 10 according to the fifth example embodiment will be described.

As described in FIG. 10, in the learning system 10 according to the fifth example embodiment, images corresponding to the frame rate for operation of the feature amount extraction unit 120 are selected. In this way, it is possible to perform more appropriate learning in assumption of motions at the moment when the operation of the feature amount extraction unit 120 after learning is operated.

### Sixth Example Embodiment

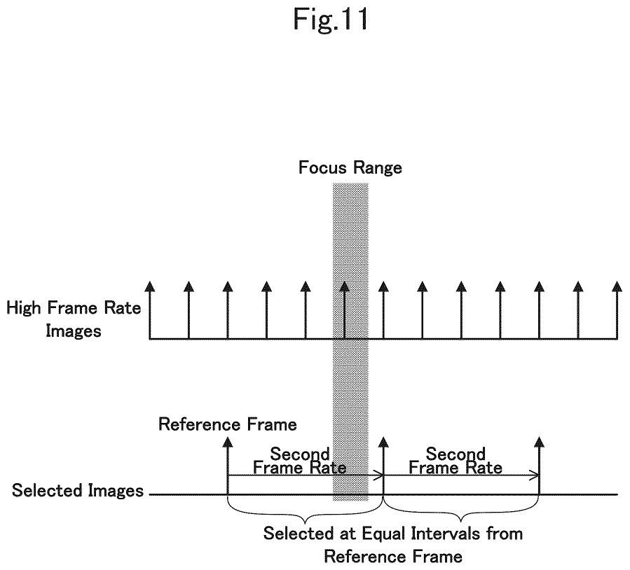

The learning system 10 according to a sixth example embodiment will be described with reference to FIG. 11. Incidentally, the sixth example embodiment only differs in some configurations and operations as compared with the first through fifth example embodiments described above, and with respect to the others the sixth example embodiment may be the same as the first through fifth example embodiments. Accordingly, in the following, the descriptions overlapping with the example embodiments already described will be omitted as appropriate.

### Operation Example

First, an operation example of the learning system 10 according to the sixth example embodiment will be described with reference to FIG. 11. FIG. 11 is a conceptual diagram illustrating an operation example of the learning system according to the sixth example embodiment.

As shown in FIG. 11, in the learning system 10 according to the sixth example embodiment, the image selection unit 110 first selects a reference frame. That is, the image selection unit 110 selects one reference frame from a plurality of high frame rate images. The reference frame may be randomly selected from the high frame rate images.

Thereafter, the image selection unit 110 further selects another image corresponding to the second frame rate based on the reference frame. Specifically, the image selection unit 110 selects a second image at intervals corresponding to the second frame rate from the reference frame. The image selection unit 110 selects a third image at intervals corresponding to the second frame rate from the second image. Here, an example of selecting three images, but in a similar way, the fourth and subsequent images may be selected.

### Technical Effects

Next, technical effects obtained by the learning system 10 according to the sixth example embodiment will be described.

As described in FIG. 8, in the learning system 10 according to the sixth example embodiment, based on the reference frame that is first selected, the other images are selected. frame images for learning are selected from high frame rate data by the above-described selection method. By using the selected frame images for learning, it is possible to learn the optimal network for estimating the low frame rate.

### Seventh Example Embodiment

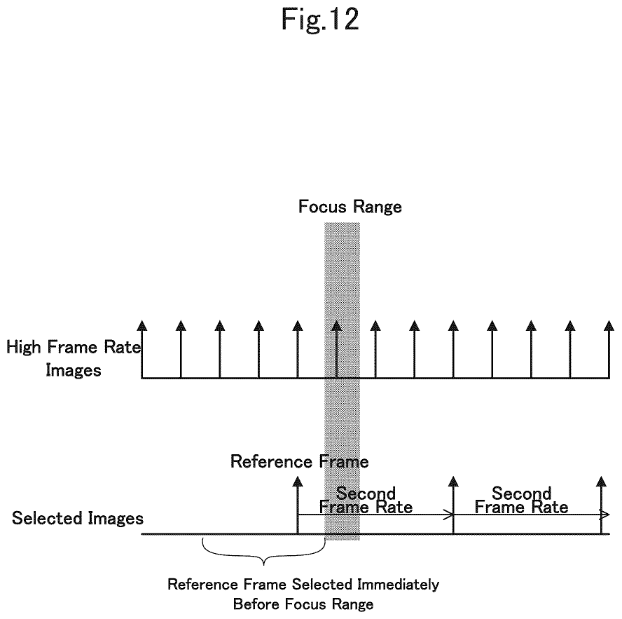

The learning system 10 according to a seventh example embodiment will be described with reference to FIG. 12. Incidentally, the seventh example embodiment only differs in some configurations and operations as compared with the sixth example embodiment described above, and with respect to the others the seventh example embodiment may be the same as the first to sixth example embodiments. Accordingly, in the following, the description of the portions overlapping with the example embodiments already described will be omitted as appropriate.

### Operation Example

First, an operation example of the learning system 10 according to the seventh example embodiment will be described with reference to FIG. 12. FIG. 12 is a conceptual diagram illustrating an operation example of the learning system according to the seventh example embodiment.

As shown in FIG. 12, in the learning system 10 according to the seventh example embodiment, the image selection unit 110 selects the reference frame from immediately before the focus range. Here, “immediately before the focus range” means a relatively close position in front of the focus range. “Immediately before the focus range” is set as, for example, a range that falls within a predetermined distance from the front end of the focus range. The image selected as the reference frame is not limited to the image taken the most closely to the focus range. In the example shown in FIG. 12, the first image existing outside the imaging range is selected as the reference frame. However, an image taken earlier than the first image may be selected as the reference frame. When there are a plurality of high rate images in a range, which can be said to be immediately before the focus range, the image selection unit 110 may randomly select one image from them as the reference frame.

### Technical Effects

Next, technical effects obtained by the learning system 10 according to the seventh example embodiment will be described.

As described in FIG. 8, in the learning system 10 according to the seventh example embodiment, the reference frame is selected from immediately before the imaging range. In this way, a plurality of images located around the focus range can be the selected images. Therefore, it is possible to easily and efficiently select images suitable for learning.

### Eighth Example Embodiment

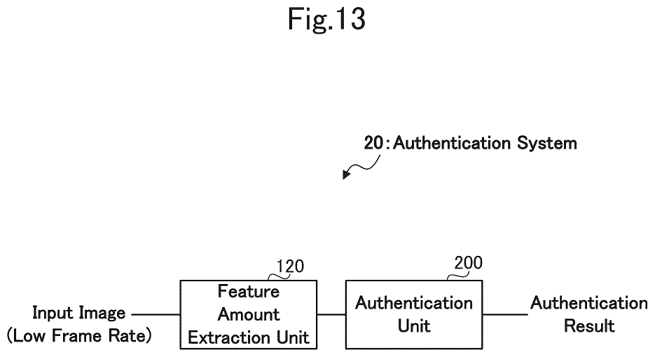

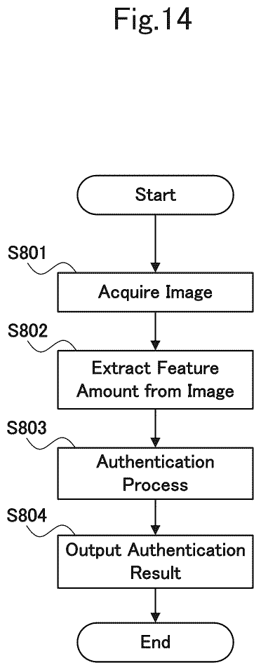

The authentication system 20 according to an eighth example embodiment will be described with reference to FIGS. 13 and 14. The authentication system 20 according to the eighth example embodiment is a system including a feature amount extraction unit 120 learned by the learning system 10 according to the first through seventh example embodiments described above. A hardware configuration of the authentication system 20 according to the eighth example embodiment may be the same as in the learning system 10 (see FIG. 1) according to the first example embodiment, and also with respect to the others the eighth example embodiment may be similar to the learning system 10 according to the first through seventh example embodiments. Accordingly, in the following, the descriptions overlapping with the example embodiments already described will be omitted as appropriate.

### Functional Configuration

First, a functional configuration of the authentication system 20 according to the eighth example embodiment will be described with reference to FIG. 13. FIG. 13 is a block diagram illustrating the functional configuration of the authentication system according to the eighth example embodiment. In FIG. 13, the reference signs same as in FIG. 2 are assigned to the elements similar to in FIG. 2 respectively.

As shown in FIG. 13, the authentication system 20 according to the eighth example embodiment is configured to include the feature amount extraction unit 120 and the authentication unit 200 as processing blocks for realizing the functions of the authentication system 20. The authentication unit 200 may be realized, for example, by the processor 11 described above (see FIG. 1). Alternatively, the authentication unit 200 may be realized by an external server or cloud.

As described in each of the above-described example embodiments, the feature amount extraction unit 120 is configured to be capable of extracting the feature amount from an image. The feature amount extraction unit 120 according to the eighth example embodiment has been learned by the learning system 10 described in the first through seventh example embodiments. The feature amount extracted by the feature amount extraction unit 120 is outputted to the authentication unit 200.

The authentication unit 200 is configured to be capable of executing an authentication process using the feature amount extracted by the feature amount extraction unit 120. For example, the authentication unit 200 is configured to be capable of performing biometric authentication using an image where a living body has been imaged. The authentication unit 200 may be configured to be capable of executing iris authentication using the feature amount of the iris extracted from the iris image. Existing techniques can be adopted as appropriate as a specific method for the authentication process. Accordingly, the detailed description of the specific method will be omitted here.

(Flow of Operations) Next, referring to FIG. 14, a flow of operations of the authentication system 20 according to the eighth example embodiment will be described. FIG. 14 is a flowchart illustrating the flow of operations of the authentication system according to the eighth example embodiment.

As shown in FIG. 14, when the authentication system 20 according to the eighth example embodiment operates, first, the feature amount extraction unit 120 acquires an image (Step S801). The image acquired here may be, for example, an image taken at a low frame rate assumed at the moment of learning. An image taken by a camera, for example, may be directly inputted to the feature amount extraction unit 120 as it is. Alternatively, an image stored in a storage or the like may be inputted to the feature amount extraction unit 120.

Subsequently, the feature amount extraction unit 120 extracts the feature amount from the acquired image (Step S802). The feature amount extraction unit 120 outputs the extracted feature amount to the authentication unit 200.

Subsequently, the authentication unit 200 executes the authentication process using the feature amount extracted by the feature amount extraction unit 120 (Step S803). The authentication unit 200 may read out, for example, the feature amount registered in the registration database. Then, the authentication unit 200 may determine whether or not the read feature amount matches the feature amount extracted by the feature amount extraction unit 120. When the authentication process ends, the authentication unit 200 outputs the authentication result (Step S804).

### Technical Effects

Next, technical effects obtained by the authentication system 20 according to the eighth example embodiment will be described.

As described in FIGS. 13 and 14, in the authentication system 20 according to the eighth example embodiment, the authentication process is executed using the feature amount extraction unit 120 learned by the learning system 10 according to the first through seventh example embodiments. As already described, the learning of the feature amount extraction unit 120 is performed using the part of the high frame rate images (including the image taken in the focus range) selected from the high frame rate images. Therefore, even if the input image is not taken in the focus range, it is possible to accurately extract the feature amount of the image. Therefore, according to the authentication system 20 according to the eighth example embodiment, when an image has been taken either in or outside of the focus range is inputted, it is possible to output an accurate authentication result.

### Ninth Example Embodiment

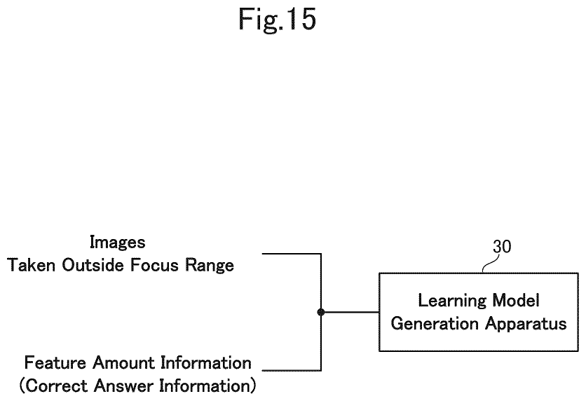

The learning model generation apparatus according to the ninth example embodiment will be described with reference to FIG. 15. FIG. 15 is a block diagram illustrating a functional configuration of a learning model generation apparatus according to the ninth example embodiment. Note that the learning model generation apparatus according to the ninth example embodiment may have a part of its configuration and its operations common to the learning system 10 according to the first to seventh example embodiments described above. Accordingly, in the following, the descriptions overlapping with the example embodiments already described will be omitted as appropriate.

As shown in FIG. 15, the learning model generation apparatus 30 according to the ninth example embodiment uses as input, images taken outside the focus range and the information indicating the feature amount included in the images (that is, the correct answer information). The learning model generation apparatus 30 is configured to be capable of generating a learning model by performing machine learning using the images inputted and the information indicating the feature amount. The learning model is a model which is designed, for example, as a neural network, which uses an image taken outside the focus range as the input image and outputs information about the feature amount of the input image.

As described in FIG. 15, in the learning model generation apparatus 30 according to the ninth example embodiment, the machine learning is performed using the images taken outside the focus range (i.e., not in focus). Thereby, it is possible to generate a model capable of outputting with accuracy information about the feature amount from an image taken outside the focus range. That is, it is possible to generate a model capable of outputting with accuracy information about the feature amount, even when inputted is an image with respect to which it is difficult to accurately output the feature amount due to being taken outside the focus range.

### Tenth Example Embodiment

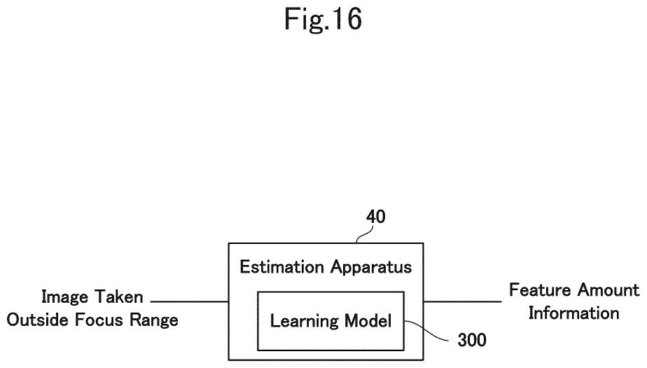

An estimation apparatus according to the tenth example embodiment will be described with reference to FIG. 16. FIG. 16 is a block diagram showing the functional configuration of the estimation apparatus according to the tenth example embodiment. The learning model generation apparatus according to the tenth example embodiment is an apparatus comprising the learning model generated by the learning model generation apparatus 30 according to the ninth example embodiment described above. Accordingly, in the following, the descriptions overlapping with the example embodiments already described will be omitted as appropriate.

As shown in FIG. 16, the estimation apparatus 40 according to the tenth example embodiment is configured to comprise a learning model 300. The learning model 300 is a model that is machine-learned using images taken outside the focus range and the information indicating the feature amount included in the images (i.e., correct answer information), as described in the ninth example embodiment. The estimation apparatus 40 uses an image taken outside the focus range as an input image, and outputs information about the feature amount of the input image. More specifically, the estimation apparatus 40 uses the learning model 300 to acquire the feature amount from the input image. Then, the estimation apparatus 40 outputs as the estimation result, the feature amount of the image acquired using the learning model 300.

As described in FIG. 16, in the estimation apparatus 40 according to the tenth example embodiment, the feature amount of an image is estimated with the learning model 300 learned using images taken outside the focus range. Thereby, it is possible to accurately estimate information about the feature amount from an image taken outside the focus range. That is, it is possible to estimate with accuracy information about the feature amount, even when inputted is an image with respect to which it is difficult to accurately output the feature amount due to being taken outside the focus range.

Also included in the scope of each example embodiment is a processing method comprising the steps of: recording in a recording medium, a computer program to operate the configuration of each above-mentioned example embodiment so as to realize the functions of each example embodiment; reading out the computer program recorded in the recording medium as code; and executing the computer program in a computer. In other words, a computer-readable recording medium is also included in the scope of each example embodiment. In addition, not only the recording medium where the above-mentioned computer program is recorded but also the computer program itself is included in each embodiment.

For example, a floppy disk (registered trademark), a hard disk, an optical disk, an optical magnetic disk, a CD-ROM, a magnetic tape, a non-volatile memory cards and a ROM can be each used as the recording medium. In addition, not only the computer program recorded on the recording medium that executes processing by itself, but also the computer program that operates on an OS to execute processing in cooperation with other software and/or expansion board functions is included in the scope of each embodiment.

This disclosure can be modified as necessary to the extent that does not contradict the concept or idea of the invention which can be read from the entire claims and the entire specification; and the learning system, the authentication system, the learning method, the computer program, the learning model generation apparatus, and the estimation apparatus with such modifications are also included in the technical concept of this disclosure.

### Supplementary Note

With respect to the example embodiments described above, they may be further described as in supplementary notes below, but are not limited to the following.

### (Supplementary Note 1)

A learning system described as the supplementary note 1 is a learning system that comprises: a selection unit that selects from images corresponding to a plurality of frames shot at a first frame rate, part of the images, the part including an image taken outside a focus range; an extraction unit that extracts a feature amount from the part of the images; and a learning unit that performs learning for the extraction unit based on the feature amount extracted and correct answer information indicating a correct answer with respect to the feature amount.

### (Supplementary Note 2)

A learning system described as the supplementary note 2 is the learning system according to the supplementary note 1, wherein the images corresponding to the plurality of frames each include an iris of a living body, and the extraction unit extracts the feature amount to be used for iris authentication.

### (Supplementary Note 3)

A learning system described as the supplementary note 3 is the learning system according to the supplementary note 1 or 2, wherein the selection unit selects at least one image in a vicinity of the focus range as the part of the images.

### (Supplementary Note 4)

A learning system described as the supplementary note 4 is the learning system according to any one of the supplementary notes 1 to 3, wherein the selection unit selects as the part of the images, images corresponding to a second frame rate lower than the first frame rate.

### (Supplementary Note 5)

A learning system described as the supplementary note 5 is the learning system according to the supplementary note 4, wherein the second frame rate is a frame rate for operation of the extraction unit learned by the learning unit.

### (Supplementary Note 6)

A learning system described as the supplementary note 6 is the learning system according to the supplementary note 4 or 5, wherein the selection unit selects one reference frame from the part of the images and then select other images corresponding to the second frame rate based on the reference frame.

### (Supplementary Note 7)

A learning system described as the supplementary note 7 is the learning system according to the supplementary note 6, wherein the selection unit is configured to select the reference frame from images taken immediately before the focus range.

### (Supplementary Note 8)

An authentication system described as the supplementary note 8 is an authentication system comprising an extraction unit and an authentication unit, wherein the extraction unit selects from images corresponding to a plurality of frames shot at a first frame rate, part of the images, the part including an image taken outside a focus range, and extracts a feature amount from the part of the images, the extract unit being learned based on the feature amount extracted and correct answer information indicating a correct answer with respect to the feature amount; and the authentication unit executes an authentication process using the feature amount extracted.

### (Supplementary Note 9)

A learning method described as the supplementary note 9 is a learning method comprising: selecting from images corresponding to a plurality of frames shot at a first frame rate, part of the images, the part including an image taken outside a focus range; extracting a feature amount from the part of the images; and performing learning for the extraction based on the feature amount extracted and correct answer information indicating a correct answer with respect to the feature amount.

### (Supplementary Note 10)

A Computer program described as the supplementary note 10 is a computer program that allows a computer to: select from images corresponding to a plurality of frames shot at a first frame rate, part of the images, the part including an image taken outside a focus range; extract a feature amount from the part of the images; and perform learning for the extraction based on the feature amount extracted and correct answer information indicating a correct answer with respect to the feature amount.

### (Supplementary Note 11)

A recording medium described as the supplementary note 11 is a recording medium which records a computer program according to the supplementary note 10.

### (Supplementary Note 12)

A learning model generation apparatus described as the supplementary note 12 is a learning model generation apparatus that generates by performing machine learning where a pair of an image taken outside a focus range and information indicating a feature amount of the image is used as teacher data, a learning model that uses an image taken outside the focus range as input image and outputs information about a feature amount of the input image.

### (Supplementary Note 13)

An estimation apparatus described as the supplementary note 13 is an estimation apparatus that uses with a learning model generated by performing machine learning where a pair of an image taken outside a focus range and information indicating a feature amount of the image is used as teacher data, an image taken outside the focus range as an input image to estimate a feature amount of the input image.

### DESCRIPTION OF REFERENCE SIGNS

10 Learning system
20 Authentication system
30 Learning model generation apparatus
40 Estimation apparatus
110 Image selection unit
120 Feature amount extraction unit
130 Learning unit
131 Loss function calculation unit
132 Gradient calculation unit
133 Parameter update unit
200 Authentication unit
300 Learning model

What is claimed is:

1. A learning system comprising:
at least one memory configured to store instructions; and
at least one processor configured to execute the instructions to:
select from images corresponding to a plurality of frames shot at a first frame rate, part of the images, the part including an image taken outside a focus range;
extract a feature amount from the part of the images; and
perform learning for the extraction based on the feature amount extracted and correct answer information indicating a correct answer with respect to the feature amount.

2. The learning system according to claim 1, wherein
the images corresponding to the plurality of frames each include an iris of a living body, and
the at least one processor is configured to execute the instructions to
extract the feature amount to be used for iris authentication.

3. The learning system according to claim 1, wherein
the at least one processor is configured to execute the instructions to
select at least one image in a vicinity of the focus range as the part of the images.

4. The learning system according to claim 1, wherein
the at least one processor is configured to execute the instructions to
select as the part of the images, images corresponding to a second frame rate lower than the first frame rate.

5. The learning system according to claim 4, wherein
the second frame rate is a frame rate for operation of the extraction learned.

6. The learning system according to claim 4, wherein
the at least one processor is configured to execute the instructions to
select one reference frame from the part of the images and then select other images corresponding to the second frame rate based on the reference frame.

7. The learning system according to claim 6, wherein
the at least one processor is configured to execute the instructions to
select the reference frame from images taken immediately before the focus range.

8. (canceled)

9. A learning method comprising:
selecting from images corresponding to a plurality of frames shot at a first frame rate, part of the images, the part including an image taken outside a focus range;
extracting a feature amount from the part of the images; and
performing learning for the extraction based on the feature amount extracted and correct answer information indicating a correct answer with respect to the feature amount.

10. A non-transitory recording medium on which a computer program that allows a computer to:
select from images corresponding to a plurality of frames shot at a first frame rate, part of the images, the part including an image taken outside a focus range;
extract a feature amount from the part of the images; and
perform learning for the extraction based on the feature amount extracted and correct answer information indicating a correct answer with respect to the feature amount.

11-12. (canceled)
